(19) United States
(12) Patent Application Publication
(10) Pub. No.: US 2004/0205639 A1
(43) Pub. Date: Oct. 14, 2004

(54) Apparatus and method for printing multiple related web pages

(75) Inventors: Jacqueline Claire Drane, Austin, TX (US); Nyralin Novella Kline, Round Rock, TX (US); Jessica Kelley Murillo, Hutto, TX (US); Joshua Edwin Phillips, Austin, TX (US); Johnny Meng-Han Shieh, Austin, TX (US)

Correspondence Address: Mr. Volel Emile, P.O. Box 202170, Austin, TX, 78720-2170, US

(73) Assignee: International Business Machines Corporation, Armonk, NY

(21) Appl. No.: 09/971,125

(22) Filed: Oct. 4, 2001

(51) Int. Cl. G06F 17/00

(52) U.S. Cl. 715/527

(57) ABSTRACT

An apparatus and method of printing multiple related Web pages are provided. The apparatus and method may be a print plug-in module which when invoked generates a visual representation of Web pages related to a displayed Web page. The display of the pages is in a tree structure whereby the root of the tree is the displayed page. Displaying the pages in a tree structure provides an order in which the Web pages relate to each other. The printing of the Web pages is user-selectable.

### BACKGROUND OF THE INVENTION

1. Technical Field

The present invention is directed to printing Web pages. More specifically, the present invention is directed to an apparatus and method of printing multiple related Web pages.

2. Description of Related Art

As is well known by now, the World Wide Web (WWW) or Internet is a system of servers that support specially formatted documents. The documents are formatted in a script called Hyper Text Markup Language (HTML) that supports links (reference addresses) to other documents as well as graphics, audio and video files. This allows a user to jump from one document or web page to another by just one click of a mouse or any other pointing device.

Due to the number of servers that make up the Internet, a great amount of information is readily available to a user. This information is presented in HTML documents called Web pages. Each Web page has an address or URL (Uniform Resource Locator) specifying where exactly it is located. The user, armed with a URL, may access, display and print a Web page.

Often times, an HTML document is so voluminous that, for ease of use, it is broken up into multiple Web pages. Thus, to print the document, a user has to access and display each Web page that makes up the document. Obviously depending on the number of pages, this can be a rather tedious and time-consuming endeavor.

Realizing this problem, some Web sites sometime offer a duplicate copy of the document on one Web page. However, providing two copies of the document wastes disk space. Furthermore, both copies of the document have to be updated when a change is made to the document.

Another solution has been to provide a browser plug-in that enables all the Web pages (including links) that make up the document to be printed with one print command. (A plug-in is a hardware or software device that adds a specific feature or service to a larger system.) Sometime, however, many links in the document may be irrelevant to the wanted information. Thus, not only printer resources, such as ink and paper, are wasted, the user has to also sort through the printed pages and discard the unwanted information.

What is needed, therefore, is an apparatus and method to graphically display for selective printing, pages from a multiple-Web-page document distinguishing pages containing relevant information from those containing irrelevant information.

### SUMMARY OF THE INVENTION

The present invention provides an apparatus and method of printing multiple related Web pages. The present invention uses a print plug-in module that when invoked generates a visual representation of Web pages related to a displayed Web page. The display of the pages is in a tree structure whereby the root of the tree is the displayed page. Displaying the pages in a tree structure provides an order in which the Web pages relate to each other. The printing of the Web pages is user-selectable.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 is a graphical representation of a Web client and server incorporating the present invention.

FIG. 5 is a process used by the present invention to print multiple related Web pages.

FIG. 6 is a visual representation of a display of related Web pages.

### DETAILED DESCRIPTION OF THE PREFERRED EMBODIMENT

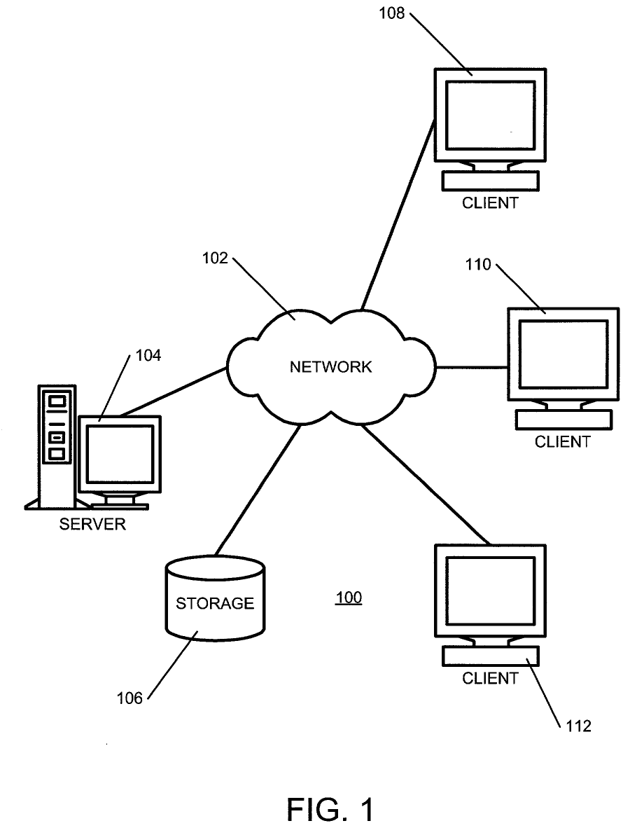

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

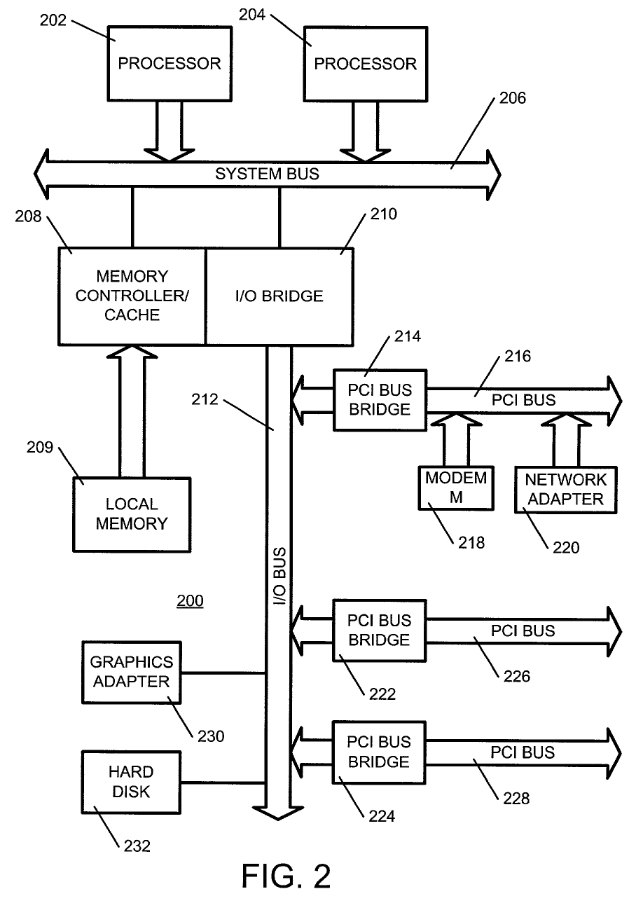

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

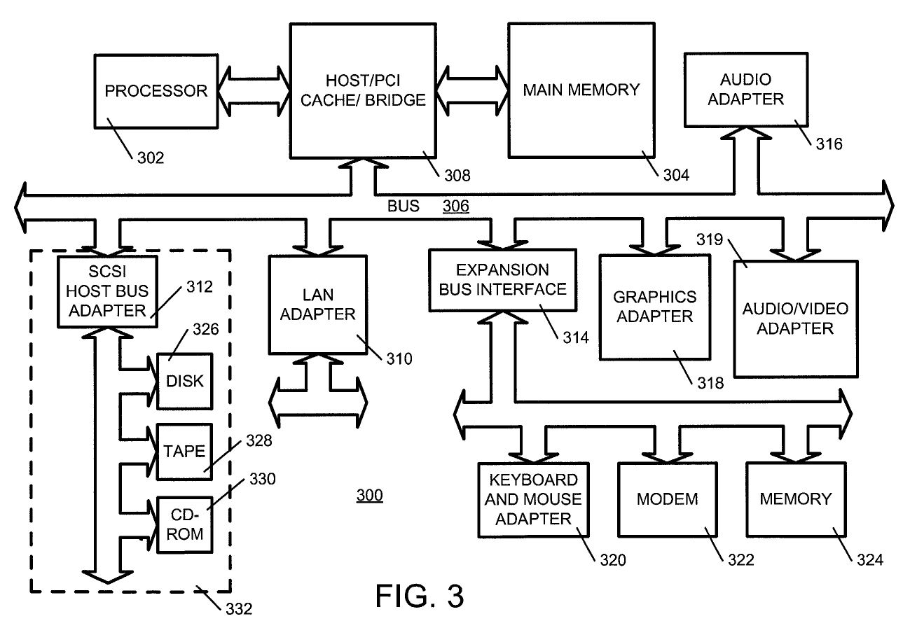

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides a plug-in to a browser print service that displays for user printing selection, Web pages from a multi-Web-page document distinguishing Web pages having embedded links containing relevant information from those having embedded links containing irrelevant information. The invention may be local to client systems 108, 110 and 112 of FIG. 1 or to the server 104 or to both the server 104 and clients 108, 110 and 112. Consequently, the present invention may reside on any data storage medium (i.e., floppy disk, compact disk, hard disk, ROM, RAM, etc.) used by a computer system.

The invention consists of an applet that may reside either on the server 104 or on any of the client systems 108, 110 and 112 in conjunction with a regular. Any of the programs executing on the server 104 are referred to generically herein as Web server programs and those executing on any of the clients are referred to Web client programs.

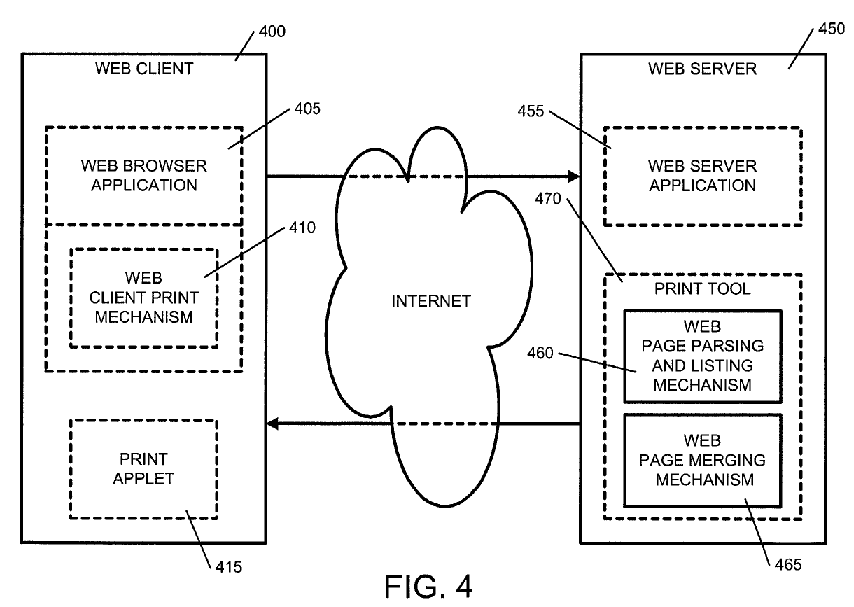

FIG. 4 is a graphical representation of a Web client and server incorporating the present invention. Web client 400 includes a Web browser application 405 and a print applet 415. The function of a Web browser is to locate and display Web pages. The Web browser may also print Web pages using Web client print mechanism 410. The function of a browser is well-known in the art and thus is not discussed further. Print applet 415 is a small application program such as a Java applet that is invoked when a user selects a particular “print button” on a Web page that contains the applet. Print applet 415 is shown to reside on Web client 400, but those skilled in the art will recognize that print applet 415 are typically dynamically loaded from Web server 450 with a Web page. To print related pages of a multi-page Web document, a user needs only asserts the “print button” on a Web page that corresponds to print applet 415 to indicate that printing of the currently displayed page and related pages is desired.

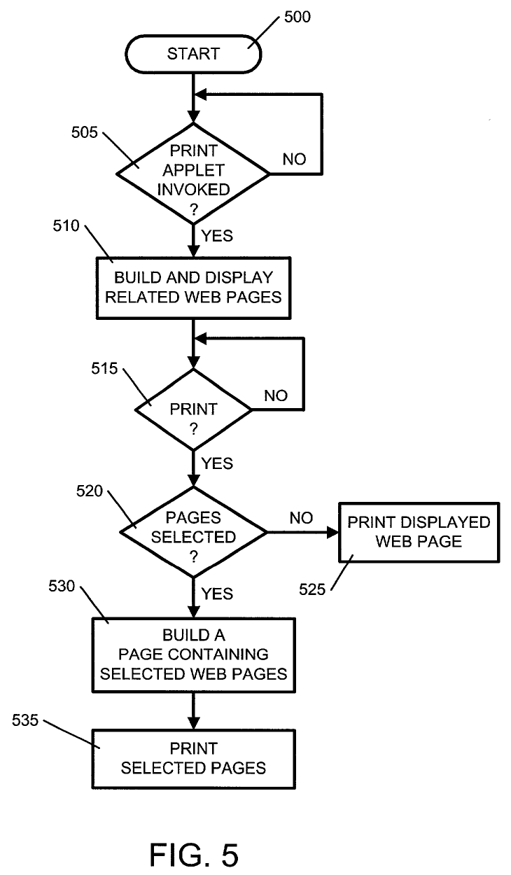

Web server 450 includes a Web server application 455 and a print tool program 470. Print tool program 470 is used in conjunction with print applet 415 to print multiple related pages. Print tool 470 includes a Web parsing and listing mechanism 460 and a Web page merging mechanism 465. The functions of mechanism 460 and 465 are discussed in FIG. 5.

FIG. 5 is a process used by the present invention to print multiple related Web pages. The process starts when the Web client through the browser accesses a Web page (step 500). A check is continuously being made as to whether the print applet is invoked (step 505). This occurs, when the user asserts the print applet button. If the applet is invoked, the applet builds and displays all related Web pages to the displayed page (510). Related Web pages, in this instance, include all pages that make up the document.

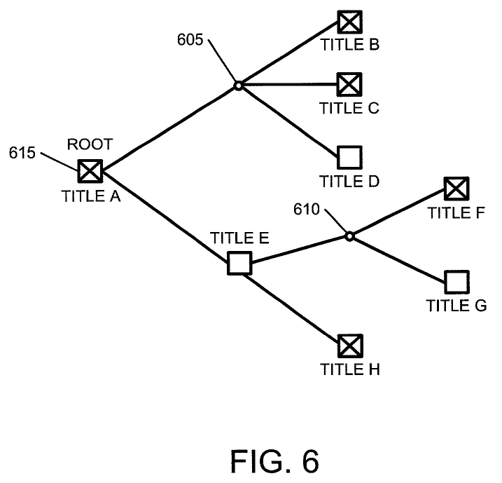

FIG. 6 is a visual representation of the display of the related Web pages. Each related Web page is shown as a node or branch in a tree structure. The title of a Web page that corresponds to a node is displayed under a check box. The check boxes are for the user to select which of the related Web pages are to be printed. In this example, Web pages that do not have relevant information, such as Web pages containing only links to other Web pages, do not have an associated check box (see reference numerals 605 and 610). Note that, the invention can easily be implemented to represent each Web page, whether containing relevant information or not, as a box.

The check boxes with an “X” printed therein are the Web pages selected by the user to be printed. Root node 615 represents the currently displayed Web page. However as is well known in the art, it need not be. For example, the applet may work both backward and forward from the displayed Web page to collect all related pages. The collected Web pages may then be displayed as shown in FIG. 6 with an added feature that lets the user know the page currently being displayed.

The invention may further be implemented with a feature that lets a user designate all nodes below a certain node to be printed. The feature may also allow the user to deselect certain nodes from the designated nodes. Additionally, the user may also be allowed to select the sub-branches to print and in what order they are to be printed. Note that, the number of levels of links or nodes displayed can a default number or a user-selectable number.

Returning to FIG. 5, when the user is ready to actually print the pages, a check is made as to whether any one of the pages is selected. If none are selected, the currently displayed Web page may by default be printed or an error may be generated (steps 515, 520 and 525). If the currently displayed page will by default be printed then in FIG. 6, the root node will always be selected for printing. In any case, if some or all the pages are selected, the applet will build the selected Web pages onto one Web page to be printed, being mindful of course of the order in which they are to be printed (steps 515, 520, 530 and 535).

The description of the present invention has been presented for purposes of illustration and description, and is not intended to be exhaustive or limited to the invention in the form disclosed. Many modifications and variations will be apparent to those of ordinary skill in the art. For example, the Web pages need not part of one Web document. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of printing multiple related Web pages comprising the steps of:
generating a visual representation of an order in which the pages are related to each other;
displaying the visual representation of the related pages, each related page being user-selectable for printing; and
printing each user-selected page.

2. The method of claim 1 wherein the order is a tree structure order with a root node as a starting Web page.

3. The method of claim 2 wherein related pages having irrelevant information are not user-selectable.

4. The method of claim 3 wherein the starting Web page is a presently displayed Web page.

5. The method of claim 4 wherein the Web pages have embedded references to other Web pages, the generating step including the step of parsing the displayed Web page and each referenced Web page in order to gather and display the pages in the tree structure order.

6. A computer program product on a computer readable medium for printing multiple related Web pages comprising:
code means for generating a visual representation of an order in which the pages are related to each other;
code means for displaying the visual representation of the related pages, each related page being user-selectable for printing; and
code means for printing each user-selected page.

7. The computer program product of claim 5 wherein the order is a tree structure order with a root node as a starting Web page.

8. The computer program product of claim 7 wherein related pages having irrelevant information are not user-selectable.

9. The computer program product of claim 8 wherein the starting Web page is a presently displayed Web page.

10. The computer program product of claim 9 wherein the Web pages have embedded references to other Web pages, the generating code means including code means for parsing the displayed Web page and each referenced Web page in order to gather and display the pages in the tree structure order.

11. An apparatus for printing multiple related Web pages comprising:
means for generating a visual representation of an order in which the pages are related to each other;
means for displaying the visual representation of the related pages, each related page being user-selectable for printing; and
means for printing each user-selected page.

12. The apparatus of claim 11 wherein the order is a tree structure order with a root node as a starting Web page.

13. The apparatus of claim 12 wherein related pages having irrelevant information are not user-selectable.

14. The apparatus of claim 13 wherein the starting Web page is a presently displayed Web page.

15. The apparatus of claim 14 wherein the Web pages have embedded references to other Web pages, the generating means including means for parsing the displayed Web page and each referenced Web page in order to gather and display the pages in the tree structure order.

16. A computer system for printing multiple related Web pages comprising:
a memory device for storing code data;
a processor for processing said code data, said code data including code means for generating a visual representation of an order in which the pages are related to each other, code means for displaying the visual representation of the related pages, each related page being user-selectable for printing, and code means for printing each user-selected page.

17. The computer system of claim 16 wherein the order is a tree structure order with a root node as a starting Web page.

18. The computer system of claim 17 wherein related pages having irrelevant information are not user-selectable.

19. The computer system of claim 18 wherein the starting Web page is a presently displayed Web page.

20. The computer system of claim 19 wherein the Web pages have embedded references to other Web pages, the generating code means including code means for parsing the displayed Web page and each referenced Web page in order to gather and display the pages in the tree structure order.
